(19) United States
(12) Patent Application Publication
(10) Pub. No.: US 2015/0189867 A1
(43) Pub. Date: Jul. 9, 2015

(54) Silver-Loaded Microparticles and Loading of Same Into Silicones

(71) Applicant: Dow Corning Corporation, Midland, MI (US)

(72) Inventors: Laurie Kroupa, Delaware, OH (US); Donald Liles, Midland, MI (US); Regina Malczewski, Midland, MI (US); Shawn Mealey, Midland, MI (US); Do-Lung Pan, Taipei (TW); Randall Schmidt, Midland, MI (US); Nick Shephard, Midland, MI (US); Christine Weber, Pinconning, MI (US); Shengqing Xu, Midland, MI (US)

(73) Assignee: Dow Corning Corporation, Midland, MI (US)

(21) Appl. No.: 14/409,063

(22) PCT Filed: Mar. 14, 2013
(86) PCT No.: PCT/US13/31353

§ 371 Date: Dec. 18, 2014

Related U.S. Application Data
(60) Provisional application No. 61/663,196, filed on Jun. 22, 2012.

(51) Int. Cl. A01N 25/10; A01N 59/16

(52) U.S. Cl. CPC A01N 25/10; A01N 59/16

(57) ABSTRACT

Provided in various embodiments are methods of loading solid microparticles and nanoparticles of silver, including silver-based compounds, on silicone particles to surface modify the silicone particles. The silver-loaded microparticles and silver-loaded nanoparticles can be dispersed or loaded into silicones for use in antimicrobial and other applications.

### FIELD OF THE INVENTION

The invention relates to methods of loading solid microparticles and nanoparticles of silver, including silver-based compounds, on silicone particles to surface modify the silicone particles. The silver-loaded microparticles and silver-loaded nanoparticles can be dispersed or loaded into silicones for use in antimicrobial and other applications.

### BACKGROUND OF THE INVENTION

While techniques for loading by coating of silver onto or into inorganic particles such as glass or ceramic and polymer particles such as polystyrene and melamine are known, the loading of silver into silicones (such as silicone elastomers and gels) is much more difficult due to the large differences in density between these materials and their poor miscibility. The use of silicones as silver carriers is desirable as silicones provide numerous advantages such as lower toxicity, higher biocompatibility, lower density, and higher elastomeric properties when compared to traditional silver-carriers (inorganic particles such as glass or ceramic and polymer particles such as polystyrene and melamine). The inventive methods described herein improve the dispersion of silver, including silver-based compounds, into silicones including liquid silicones, thereby decreasing the required amount of silver while providing the same level of antimicrobial behavior and other advantageous properties as would be exhibited by larger amounts of silver.

Another issue with the prior techniques of loading silver into silicones is the precipitation of the silver into a liquid silicone matrix during storage. The inventive methods described herein provide a longer shelf life once the silver-loaded microparticles and silver-loaded nanoparticles are loaded into liquid silicones. This provides a commercial advantage for the resulting curable silicone dispersion containing the silver-loaded microparticles and silver-loaded nanoparticles as the products can remain on the shelf longer without precipitation, while still providing effective antimicrobial behavior and other advantageous properties.

Therefore, what is needed in the art are improved methods for loading solid microparticles and nanoparticles of silver and silver-based compounds onto silicone particles and for loading those silver-loaded microparticles or silver-loaded nanoparticles into a curable silicone dispersion. This invention answers that need.

### SUMMARY OF THE INVENTION

The present disclosure relates to methods of loading solid microparticles and nanoparticles of silver, including silver-based compounds, on silicone particles to surface modify the silicone particles.

A curable silver-containing silicone dispersion having stability against precipitation of silver solid may be formed by providing silicone particles, silver-containing particles and a silicone formulation; mixing the silicone particles with the silver-containing particles to form silver-loaded silicone particles; and loading the silver-loaded silicone particles into a silicone formulation by mixing to form a curable silver-containing silicone dispersion having stability against precipitation of the silver-containing particles. The mixing may be by wet blending or dry blending.

In another embodiment, a curable silver-containing silicone dispersion having stability against precipitation of silver solid may be formed by providing silicone particles, silver-containing particles and a silicone formulation; treating the silicone particles with a reagent solution followed by a reactive agent to form modified silicone particles; isolating the modified silicone particles; treating the modified silicone particles with a silver-containing solution to form silver-loaded silicone particles; and loading the silver-loaded silicone particles into a silicone formulation by mixing to form a curable silver-containing silicone dispersion having stability against precipitation of the silver-containing particles.

In a still further embodiment, a curable silver-containing silicone dispersion having stability against precipitation of silver solid may be formed by providing silicone particles containing an excessive number of —SiH groups, silver-containing particles and a silicone formulation; mixing the silicone particles with a dispersion or an emulsion containing the silver-containing particles or a solution containing the silver-containing particles to form silver-loaded silicone particles; isolating the silver-loaded elastomeric particles; and loading the silver-loaded silicone particles into a silicone formulation by mixing to form a curable silver-containing silicone dispersion having stability against precipitation of the silver-containing particles.

In yet another embodiment, a curable silver-containing silicone dispersion having stability against precipitation of silver solid may be formed by providing silicone particles, silver-containing particles and a silicone formulation; depositing the silver-containing particles onto the silicone particles using physical doping conditions to form silver-loaded silicone particles; and loading the silver-loaded silicone particles into a silicone formulation by mixing to form a curable silver-containing silicone dispersion having stability against precipitation of the silver-containing particles.

In the various methods of the present disclosure, the silicone particles comprise siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group. Also in the various methods, the silver-containing particles are solid microparticles or nanoparticles of silver or silver compounds. Further, in the various methods, the silicone formulation is a liquid silicone formulation containing siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group.

The curable silver-containing silicone dispersion of the present disclosure has stability against precipitation of silver solid and comprises silver-loaded silicone particles having a loading content of silver in the range of from about 0.1 to about 70 wt. % of the total amount of the silver-loaded silicone particles. The silver-loaded silicone particles are loaded in a silicone formulation in the range of from about 0.01 to about 50 wt. % of the silicone.

Additional aspects of the invention will be apparent to those of ordinary skill in the art in view of the detailed description of various embodiments, a brief description of which is provided below.

### DETAILED DESCRIPTION

The invention relates to methods of loading solid microparticles and nanoparticles of silver, including silver-based compounds, onto silicone particles. The loading includes both coating the silver onto the surface of the silicone particles and burying the silver inside the silicone particles. The silicone particles are surface modified via the methods described herein. The loading by coating can be accomplished using a variety of techniques such as dry solid blending, wet blending, electroless deposition, chemical reactions including chemical reduction, physical deposition such as physical vapor deposition, sol-gel reaction, film deposition, chemical deposition such as chemical vapor deposition. The silver-loaded microparticles and silver-loaded nanoparticles can be dispersed or loaded into silicones including liquid silicones to form a silver silicone matrix in the form of a curable silver-containing silicone dispersion. It is contemplated that the silver-loaded microparticles and silver-loaded nanoparticles described herein may also be further treated for other functions by physical and/or chemical processes such as surface treatment, heat treatments, calcinations, light treatments, radiation, etc.

The silver-loaded microparticles or silver-loaded nanoparticles that are loaded into the silicones to form the silver silicone matrix can be used in antimicrobial and other applications. The silver-loaded microparticles or silver-loaded nanoparticles can be dispersed or loaded alone into the silicones or they can be dispersed or loaded with one or more optional antimicrobial agents into the silicones. The methods described herein provide a more uniform dispersion of the silver-loaded microparticles and silver-loaded nanoparticles and better stability against precipitation of the silver-loaded microparticles and silver-loaded nanoparticles into the silicone matrix. If loaded into liquid silicones, the resulting curable silver-containing silicone dispersion containing the silver-loaded microparticles and silver-loaded nanoparticles can remain on the shelf longer without precipitation while still providing effective antimicrobial behavior and other advantageous properties. The methods described herein may also be used to provide additional functions such as viscosity control, synergistic microbial control and the like.

### Silicone Particles

In the inventive methods described herein, silicone particles are provided. The silicone particles may be elastomeric silicone particles. The silicone particles contemplated for use in the inventive concepts described herein are silicone particles comprising siloxy units of (RR¹R²SiO_{1/2}), (R¹R²SiO_{2/2}), (RSiO_{3/2}), and/or (SiO_{4/2}) where R, R¹, R² is independently selected from hydrogen atom and a monovalent organic group including a metal-containing organic group. The silicone particles are prepared from silicones with functional groups by chemical reactions and polymerization via any process in bulk (solid, liquid, gas), solution, dispersion, or emulsion. The particle size of the silicone particles may range from about 0.1 to about 3000 microns (μm) in average diameter. In some embodiments, the silicone particles contemplated for use in the inventive concepts described herein may range from about 1 to about 500 microns (μm) in average diameter. In still further embodiments, the silicone particles contemplated for use in the inventive concepts described herein may range from about 0.5 to about 100 microns (μm) in average diameter.

The silicone particles may be hydrophobic or hydrophilic. The silicone particles may be solid particles, porous particles, hollow particles, and/or core-shell particles with silicone as the core and/or the shell.

The surface of the silicone particles contemplated for use in the inventive concepts described herein may be electrically charged (positive or negative) or non-charged/neutral. In some embodiments, it is desired that the silicone particles be positively charged.

The silicone particles may also comprise silicones reacted with other chemical compounds.

The silicone particles for use in the inventive concepts described herein facilitate the controlled delivery of a substance such as an antimicrobial. The silicone elastomeric particles are generally available as a dry powder but may also be available in an aqueous suspension.

A family of silicone elastomeric particles known as E-powders is produced by Dow Corning Toray Silicone Co., Ltd. Examples of suitable silicones that can be used herein are those described in U.S. Pat. Nos. 4,370,160, 4,742,142, 4,743,670, 5,387,624, 5,492,945, 5,945,471, 5,948,469, 5,969,039 and 7,393,582, which are hereby incorporated by reference in their entirety. These silicone elastomeric particles are prepared by various methods such as by curing liquid silicones into a wet emulsion or dispersion followed by drying, “in situ” particle formation by curing the liquid and forming into droplets, or “in situ” particle formation during liquid spraying and then curing, etc.

In U.S. Pat. No. 4,370,160, microparticles, such as microspheres and microcapsules, comprising a solid organopolysiloxane are prepared by irradiating a dispersion of discrete entities with UV light. The discrete entities are dispersed in a UV-transparent fluid continuous phase and are sphere-like particles of a UV-curable, liquid organopolysiloxane composition, or such a liquid organopolysiloxane composition containing a material to be encapsulated. In U.S. Pat. No. 4,742,142, powdered, cured silicone rubber in the form of microfine particles is prepared by emulsifying a curable liquid silicone rubber composition in a mixture of water and a surfactant at a temperature of from 0 to 25° C., dispersing the curable composition in water heated to a temperature of at least 25° C. and recovering the resultant cured particles. U.S. Pat. No. 4,743,670, cured silicone rubber in the form of a finely divided powder is prepared by dispersing a heat-curable liquid silicone rubber composition in water maintained at a temperature of from 0 to 25° C., dispersing the resultant dispersion in a liquid heated to a temperature of at least 50° C., and recovering the resultant cured powder.

In U.S. Pat. No. 5,387,624, a powder mixture of cured silicone microparticles and inorganic microparticles is prepared by (i) forming a water-based suspension of a plurality of cured silicone microparticles having an average diameter of 0.1 to 200 micrometers, a plurality of inorganic microparticles having an average particle diameter of 0.1 to 200 micrometers and, optionally, at least one surfactant; and (ii) removing the water from the water-based suspension.

In U.S. Pat. No. 5,492,945, a cured silicone rubber composition is prepared by (i) preparing a water-based dispersion of a cured silicone powder having an average particle diameter of 0.1 to 200 micrometers and an amorphous silica micropowder that has an average particle diameter not exceeding 1 micrometer and a surface silanol group density of at least 2 silanol groups per 100 square angstroms; (ii) heating the water-based dispersion; and (iii) removing the water from the dispersion. The silica micropowder is immobilized on the surface of the cured silicone powder. In U.S. Pat. No. 5,945,471, a composite powder composition having excellent flowability and water repellency is disclosed, the composition comprising: (A) 100 parts by weight of a cured silicone powder that has an average particle size of 0.1 to 500 micrometers and contains 0.5 to 80 weight percent of a non-crosslinking oil; and (B) 0.1 to 100 parts by weight of a microfine inorganic powder, the inorganic powder being coated on the surface of the cured silicone powder. In U.S. Pat. No. 5,948,469, silicone rubber particulates coated with metal oxide microparticles are prepared, wherein the metal oxide microparticles are derived from a sol. The prepared silicone rubber particulates reduce aggregation of the particulate mass.

In U.S. Pat. No. 5,969,039, cured silicone powder having a uniform particle size is prepared, in which a platinum-alkenylsilozane complex catalyst is added to a water-based dispersion of a silicone composition. The silicone composition is an organopolysiloxane having at least two silicon-bonded alkenyl groups in each molecule and an organopolysiloxane having at least two silicon-bonded hydrogen atoms in each molecule. The catalyst is added and dispersed in the form of liquid particles with an average particle size in volumetric particle size distribution in water of no more than one micron. In U.S. Pat. No. 7,393,582, composite silicone rubber particles include silicone rubber particles A and silicone rubber particles B, wherein the surface of the particles A is covered with the particles B having sizes smaller than sizes of particles A.

Non-limiting examples of suitable silicone particles that are commercially available include DOW CORNING® Trefil E-500, Trefil E-506C, Trefil E-5065, Trefil E-506W, Trefil E-507, Trefil E-508, Trefil E-521, Trefil E-600, Trefil E-601, Trefil E-606, Trefil E-71, and DOW CORNING® 9506 POWDER, available from Dow Corning Corporation in Midland, Mich.

### Silver and Silver Compounds

In the inventive methods described herein, silver-containing particles are provided. The silver and silver compounds suitable for use in the inventive concepts as the source of the silver-containing particles described herein include, but are not limited to, silver-containing liquids, solids of silver alloys, silver salts (such as silver citrate hydrate (AgO₂CCH₂C(OH)(CO₂Ag)CH₂CO₂Ag.xH₂O)), silver sulfadiazine (silver[(4-aminophenyl)sulfonyl](pyrimidin-2-yl)azanide)), silver-copper alloy, silver-tin alloy, silver carbonate (Ag₂CO₃), silver benzoate (C₆H₅CO₂Ag), silver lactate (CH₃CH(OH)COOAg), silver chloride (AgCl), silver nitrate (AgNO₃), silver sulfite (Ag₂SO₃), silver sulfate (Ag₂SO₄), silver-containing inorganic compounds (such as silver-zeolite), silver-containing organic compounds (such as silver sulfadiazine, silver citrate, silver lactate and/or silver acetate), silver-doping polymers (such as synthetic polymers, natural polymers such as sugar, protein, cellulose, and their derivatives), and the dispersion(s) of these silver solids into any liquid. The silver-containing particles may be solid microparticles or nanoparticles of metallic silver. The silver-containing particles may also be solid microparticles or nanoparticles of silver and silver compounds.

The silver and silver compounds suitable for use in the inventive concepts described herein may have varied particle sizes and shapes (such as spheres and irregular shapes such as ovals, sheets, plates, fibers, needles, bars, rods, chains, dumbbells, cages, rings, dendrimers, core-shell and/or Janus comprised of two or more materials, balloons, and the like).

### Silicones

In the inventive methods described herein, silicone formulations are provided. The silicone formulation may be selected from any types of silicone including M, D, T, Q structure into molecular compositions which are known in the art. In some embodiments, the silicone formulation that is used in the methods described herein is a liquid silicone. The silicone formulation may contain siloxy units having the formula (RR¹R²SiO_{1/2}), (R¹R²SiO_{2/2}), (RSiO_{3/2}), and/or (SiO_{4/2}); R, R¹, R² may be independently selected from a hydrogen atom and a monovalent organic group. These units may be alternatively described as organopolysiloxane segments and are known in the art as M, D, T, and Q units, respectively. In one embodiment, the silicone compositions include “M” siloxy units. In another embodiment, the silicone compositions include “D” siloxy units. In still another embodiment, the silicone compositions include “T” siloxy units. In a further embodiment, the silicone compositions include “Q” siloxy units. In even further embodiments, the silicone compositions include “M” and “D” units, “M” and “T” units, “M” and “Q” units, “D” and “T” units, “D” and “Q” units, or “T” and “Q” units.

The organopolysiloxane units in the silicone components may further include cyclic siloxane ring containing n atoms of silicon with n≧3 (preferably, n=3-6) including (R¹R²SiO_{n/n}), (RHSiO_{n/n}), (R¹R²SiO)ₙ, or (RHSiO)ₙ units, or a combination thereof.

In the formulae above, the monovalent group of R, R¹, R² is independently a hydrocarbon or halogenated hydrocarbon group including 1 to 30 carbon atoms. Non-limiting examples include alkyl groups such as methyl, ethyl, propyl, butyl, pentyl, hexyl, heptyl, octyl, undecyl, and octadecyl groups; an aliphatically unsaturated group such as an alkenyl group. Suitable alkenyl groups contain from 2 carbon to about 6 carbon atoms and may be, but not limited to, vinyl, allyl, and hexenyl; cycloalkyl groups such as cyclohexyl; aryl groups such as phenyl, tolyl, xylyl, benzyl, and 2-phenylethyl; and halogenated hydrocarbon groups such as 3,3,3-trifluoropropyl, 3-chloropropyl, and dichlorophenyl groups. The number of siloxy units may vary. The number and type of siloxy units may affect the molecular weight of the organopolysiloxane segment, and hence the molecular weight of the composition.

The R, R¹, R² groups may also include, but are not limited to, acrylate functional groups such as acryloxyalkyl groups; methacrylate functional groups such as methacryloxyalkyl groups; cyanofunctional groups; monovalent hydrocarbon groups; and combinations thereof. The monovalent hydrocarbon groups may include alkyl groups such as methyl, ethyl, propyl, isopropyl, n-butyl, s-butyl, t-butyl, pentyl, neopentyl, octyl, undecyl, and octadecyl groups; cycloalkyl groups such as cyclohexyl groups; aryl groups such as phenyl, tolyl, xylyl, benzyl, and 2-phenylethyl groups; halogenated hydrocarbon groups such as 3,3,3-trifluoropropyl, 3-chloropropyl, dichlorophenyl, and 6,6,6,5,5,4,4,3,3-nonafluorohexyl groups; and combinations thereof. The cyano-functional groups may include cyanoalkyl groups such as cyanoethyl and cyanopropyl groups, and combinations thereof.

The R, R¹, R² groups may also include alkyloxypoly(oxyalkyene) groups such as propyloxy(polyoxyethylene), propyloxypoly(oxypropylene) and propyloxy-poly(oxypropylene)-co-poly(oxyethylene) groups, halogen substituted alkyloxypoly(oxyalkyene) groups such as perfluoropropyloxy(polyoxyethylene), perfluoropropyloxypoly(oxypropylene) and perfluoropropyloxy-poly(oxypropylene) copoly(oxyethylene) groups, alkenyloxypoly(oxyalkyene) groups such as allyloxypoly(oxyethylene), allyloxypoly(oxypropylene) and allyloxy-poly(oxypropylene) copoly(oxyethylene) groups, alkoxy groups such as methoxy, ethoxy, n-propoxy, isopropoxy, n-butoxy and ethylhexyloxy groups, aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole groups, hindered aminoalkyl groups such as tetramethylpiperidinyl oxypropyl groups, epoxyalkyl groups such as 3-glycidoxypropyl, 2-(3,4,-epoxycyclohexyl)ethyl, and 5,6-epoxyhexyl groups, ester functional groups such as acetoxymethyl and benzoyloxypropyl groups, hydroxyl functional groups such as hydroxy and 2-hydroxyethyl groups, isocyanate and masked isocyanate functional groups such as 3-isocyanatopropyl, tris-3-propylisocyanurate, propyl-t-butylcarbamate, and propylethylcarbamate groups, aldehyde functional groups such as undecanal and butyraldehyde groups, anhydride functional groups such as 3-propyl succinic anhydride and 3-propyl maleic anhydride groups, carbonyl and carboxy functional groups such as 3-carboxypropyl, 2-carboxyethyl, and 10-carboxydecyl groups, functional groups of carboxalkoxy, carboxamido, amidino, nitro, cyano, primary amino, secondary amino, acylamino, alkylthio, sulfoxide, sulfone, metal salts of carboxylic acids such as zinc, sodium, and potassium salts of 3-carboxypropyl and 2-carboxyethyl groups, and combinations thereof. Any metal atoms may be included into the R groups and/or the siloxane chains.

Non-limiting examples of suitable liquid silicone formulations that are commercially available are DOW CORNING® 7-9700 SOFT SKIN ADHESIVE Part A and DOW CORNING® MG 7-9800, MG 7-9850, and MG 7-9900 SOFT SKIN ADHESIVE Part A, organopolysiloxanes available from Dow Corning Corporation in Midland, Mich. These liquid Part A compositions can be cured into gels or solids with their corresponding Part B compositions.

### Coating Via Dry Solid Blending Process

The silver microparticles and silver-loaded nanoparticles may be loaded by coating onto the silicone(s) by a dry blending process. The silver-containing particles are dry blended such as by mechanical mixing with the silicone particles to form silver-loaded silicone particles. The mechanical mixing may be any suitable type of industrial mixer such as a paddle mixer, a V blender, a ribbon blender, a double cone blender, a high shear mixer, a drum-blender including a dental mixer, a vortex mixer, a roller mixer, or the like. The dry blending process enables the silver-containing particles to be applied, depending on the materials selected, to the surface of and/or between the silicone particles. A liquid or solid dispersion aid may be added to blend the silver-containing solid particles and the silicone particles as the carrier for more uniform dispersion of the silver-containing microparticles or silver-loaded nanoparticles in and/or on the silicone particles.

The silver microparticles and/or silver-loaded nanoparticles used in the dry blending process are desirably poorly soluble into water, aqueous solutions, or organic solvents. In some embodiments, the solubility of the silver microparticles and/or silver-loaded nanoparticles is less than about 2 g/100 g water/solvent.

### Coating Via Wet Blending Process

The silver microparticles and silver-loaded nanoparticles may be loaded by coating onto the silicone(s) by a wet blending process. The silver-containing particles are wet blended with the silicone particles to form silver-loaded silicone particles. The wet blending may be via any suitable type of industrial mixer including a dental mixer, a vortex mixer, a rotary mixer, a roller mixer or the like. The wet blending process enables the silver-containing particles to be applied, depending on the materials selected, to the surface of and/or between the silicone particles.

The silver-containing solid microparticles and/or silver-loaded nanoparticles used in the wet blending process are desirably a solution or a dispersion into a liquid medium such as water, aqueous solutions, or organic solvents. In some embodiments, the concentration of the silver or the silver compound is higher than about 0.01 wt. % and, in still further embodiments, higher than about 0.5 wt. %.

### Coating Via Electroless Deposition Process

The silver-containing solid microparticles and/or silver-loaded nanoparticles may be loaded by coating onto the silicone(s) by an electroless deposition process. The electroless deposition is a chemical deposition process that deposits the silver-containing particles onto the silicone particles to form silver-loaded silicone particles. The silicone particles may be pretreated by other chemical and/or physical methods before the silver deposition. The silicone particles may be pre-loaded with other metals or chemicals prior to the silver deposition.

The electroless deposition may be accomplished via any suitable technique including chemical deposition, auto-catalytic deposition, or the like. For example, a reagent solution of silver-containing compounds may be used to treat the silicone particles, followed by one or more reactive agents in the presence of a catalyst or without any catalyst to form the coated layer on the particle surface to obtain the modified silicone particles. The modified silicone particles may be isolated and then treated with a silver-containing solution to form silver-loaded silicone particles.

The reagent solution may include any silver-containing compounds known in the art. Non-limiting examples of suitable silver-containing compounds include silver-containing liquids, solids of silver salts (such as silver nitrate (AgNO₃), silver acetate, silver citrate hydrate (AgO₂CCH₂C(OH)(CO₂Ag)CH₂CO₂Ag.xH₂O)), silver sulfadiazine, (silver[(4-aminophenyl)sulfonyl](pyrimidin-2-yl)azanide)), silver carbonate (Ag₂CO₃), silver benzoate (C₆H₅CO₂Ag), silver lactate (CH₃CH(OH)COOAg), silver sulfite (Ag₂SO₃), silver chloride (AgCl), silver sulfate (Ag₂SO₄)), silver-containing inorganic compounds (such as silver-zeolite), silver-alloys (such as silver-copper alloy, silver-tin alloy), silver-doping polymers (including synthetic polymers, natural polymers such as sugar, protein, cellulose, and their derivatives), and silver-loading inorganic particles (such as silica, CaCO₃, MgSO₄, etc.). The reactive agent for further reaction with the silver-containing reagent solution can be any kind which may generate a layer of the silver compounds on the silicone particles, thereby forming the modified silicone particles. The reactive agent enables reactions with the silver-containing compounds in the reagent solution to form silver-containing materials on the silicone particles, thereby forming the modified silicone particles. Non-limiting examples of suitable reactive agents include any reducing agent (such as borohydride (BH₄⁻), hydrazine, silicon hydride (SiH)-containing compounds), any compound containing anions of Cl⁻, SO₄²⁻ which can react with Ag⁺ to form insoluble products, and any ligand-providing compound which can react/coordinate with Ag⁺ to form stable complexes. In some cases where the Ag⁺ ions can be reduced by any physical method such as their exposure to light (visible light, ultraviolet (UV) and infrared (IR)), irradiation, and/or plasma, the reactive agent mentioned as above may be unnecessary for the silver-loading process.

The electroless deposition process enables the silver-containing particles to be applied, depending on the materials selected, to the surface of the silicone particles and/or between the silicone particles.

### Coating Via Chemical Deposition Process by Chemical Reduction

The silver microparticles and silver-loaded nanoparticles may be loaded by coating onto the silicone(s) by a chemical reduction process. The chemical reduction process is a chemical deposition process that deposits the silver-containing particles onto the silicone particles to form silver-loaded silicone particles. The silicone particles may be pretreated by other chemical and/or physical methods before the silver deposition. The silicone particles may be pre-coated with other metal or chemicals prior to the silver deposition.

The chemical reduction deposition may be accomplished via any suitable reduction process by the chemistry or physics of the silver cations or silver atoms introduced by the silver compounds to these silicone particles. Silicone particles having an excessive number of silicon hydride (—SiH) groups as the reduction agent may be mixed and/or reacted with (a) a dispersion or an emulsion containing the silver-containing particles and/or (b) the silver-containing solution to form the silver-loaded silicone particles. A physical reduction process is the silver-containing particles, which were obtained by treatment of silicone particles by silver compounds by mixing and/or reaction, to be exposed on light including visible light and ultraviolet (UV) light and/or by any radiation and/or by heat to produce a layer of silver or silver compounds to form the silver-loaded silicone particles. The silver-loaded silicone particles may be isolated and then further treated.

The electroless deposition process enables the silver-containing particles to be applied, depending on the materials selected, to the surface of the silicone particles and/or between the silicone particles.

### Coating Via Physical Deposition Process

The silver microparticles and silver-loaded nanoparticles may be loaded by coating onto the silicone(s) by a physical deposition process such as physical vapor deposition (PVD). The physical deposition process deposits the silver-containing particles onto the silicone particles to form silver-loaded silicone particles. The silicone particles may be pretreated by other chemical and/or physical methods before the silver deposition. The silicone particles may be pre-loaded with other metal or chemicals prior to the silver deposition.

The physical deposition process may be accomplished via any suitable technique including doping, sputtering, ion plating, evaporation, or the like. The physical deposition process enables the silver-containing particles to be applied, depending on the materials selected, to the surface of the silicone particles and/or between the silicone particles to form silver-loaded silicone particles.

Coating Via Additional Misc. Processes

The silicone particles may be loaded by coating onto the silicones by further techniques including the sol-gel method, film deposition methods such as the Langmuir-Blodgett film deposition method, and chemical deposition methods such as chemical vapor deposition. With the sol-gel method, a precursor of a silver-containing compound undergoes hydrolysis and polycondensation reactions with and/or in presence of the silicone(s).

The resulting silver-loaded silicone particles may be used as pesticides, antimicrobial agents (in and/or on the antimicrobial gels, antimicrobial elastomers and antimicrobial wound care devices), electrical conductive fillers and functional additives (such as antistatic additives).

### Loading

The silver-loaded microparticles and silver-loaded nanoparticles can be dispersed or loaded into silicones including liquid silicones to form a curable silver-containing silicone dispersion having stability against precipitation of silver solid particulates. The loading may be accomplished via any suitable technique including mixing or the like.

The loading content of the silver is in the range of from about 0.01 to about 99 wt. % (weight percent) of the total amount of the silver-loaded silicone particles. In alternative embodiments, the loading content of the silver is in the range of from about 0.1 to about 70 wt. % of the total amount of the silver-loaded silicone particles. In still further embodiments, the loading content of the silver is in the range of from about 0.1 to about 50 wt. % of the total amount of the silver-loaded silicone particles. Other metals and non-metals and their compounds may be loaded together with the silver and silver compounds. In other words, the silver and silver compounds may be mixtures in different chemical compositions.

The silver-loaded silicone particles are loaded in the silicone formulation in the range of from about 0.01 to about 70 wt. % of the silicone. In alternative embodiments, the silver-loaded silicone particles are loaded in a silicone formulation in the range of from about 0.01 to about 50 wt. % of the silicone. In still further embodiments, the silver-loaded silicone particles are loaded in a silicone formulation in the range of from about 0.01 to about 30 wt. % of the silicone.

The silver-loaded microparticles and silver-loaded nanoparticles can be dispersed or loaded alone into the silicones contemplated herein. In some embodiments, the silver-loaded microparticles and silver-loaded nanoparticles can be dispersed or loaded into the silicones contemplated herein with one or more optional antimicrobial agent(s) that either kill or slow the growth of microbes such as, but not limited to, antibacterial agents, antiviral agents, antifungal agents, antialgae agents and antiparisitic agents. These optional antimicrobial agents may selected from any chemical compounds and polymers such as silicones containing silanol (SiOH), silicon hydride (SiH), carbinol (Si(CH₂)xOH, where x=1-18), and phenol; sulfonium compounds; phosphonium compounds; acids such as sorbic acid (vitamin C), citric acid, salicylic acid, fatty acids and derivatives, acetic acid, benzoic acid, tannic acid, gallic acid, octadecenedioic acid, hesperedin, glycyrrhizic acid, glycyrrhetinic acid, n-acyl amino acid, hydroxyproline, niacin (vitamin B₃); aldehydes such as glutaraldehyde; alcohols such as erythritol, p-cymen-5-ol, p-cymen-7-ol, benzyl alcohol, phenol, thymol(2-isopropyl-5-methylphenol); 4-amino-N-(5-methyl-3-isoxazoly)benzenesulfonamide; quaternary ammonium compounds (QACs) such as cetyl pyridinium chloride, Poly(hexamethylene biguanide) hydrochloride (PHMB); quinolone such as 8-hydroxyquinoline; carbendazim such as benzimidazole compounds, 2-benzimidazolecarbamoyl compounds; Isothiazolinone derivatives such as n-butyl-1,2-benzisothiazolin-3-one (BBIT); methylisothiazolinone (MIT), chloromethylisothiazolinone (OMIT), benzisothiazolinone (BIT), octylisothiazolinone (OIT), dichlorooctylisothiazolinone (DCOIT), 2-n-octyl-4-isothiazolin-3-one (OBIT), 4-(1-methyl-1-mesitycyclobutane-3-yl)-2-(2-hydroxy-3-methoxybenzylidenehydrazino) thiazole; hexahydro-1,3,5-tris-hydroxyethyl-s-triazine (HHT); chitosan, chitin; halogen-containing compounds such as chlorothalonil (tetrachloro-isophthalonitrile, CHTL), 2-bromo-2-nitropropane-1,3-diol (BNP), 3-Iodo-2-propynl-n-butylcarbamate (IPBC); metal-containing compounds or alloys such copper (Cu), zinc (Zn) such as ZPT (zinc pyrithione), tin (Sn), gold (Au); 7-formyanil-substituted-imino-4-(4-methyl-2-butanone)-8-hydroxyquinoline-5-sulphonic acid complexes of cobalt, nickel or copper; As-containing compounds such as 10,10′-oxybisphenoxyarsine (OBPA); sodium pyrithione (NaPT); and proteins such as lactoferrin. The silver-loaded microparticles and silver-loaded nanoparticles can be dispersed or loaded in combination with other active agents such as antioxidants, UV absorbing agents and the like.

The silver-loaded microparticles and silver-loaded nanoparticles can also be loaded into solid silicones. The silicones may be solids such as plastics, elastomers, and gels or foam.

Fillers and/or additives may also be introduced into the curable silver-containing silicone dispersions. The fillers and/or additives may or may not react with the silicone components. The fillers and/or additives may be hydrophilic or hydrophobic, polar or nonpolar, solids and/or liquids; and polymers such as synthetic polymers, natural products and their derivatives, and/or small molecules. The fillers may provide reinforcement for the curable silver-containing silicone dispersions and/or other functions to the cured silicone solid.

### Post Loading and End Uses

The silver silicone matrix in the form of the curable silver-containing silicone dispersion can be further processed based on the desired end use(s). For example, the silver silicone matrix can be vulcanized into elastomers, gels, foams, plastics, etc. The methods described herein provide a more uniform dispersion of the silver-loaded microparticles and silver-loaded nanoparticles and better stability against precipitation of the silver-loaded microparticles and silver-loaded nanoparticles into the silver-containing silicone dispersions.

The resulting silver silicone matrices comprising the silver-loaded silicone particles dispersed or loaded into the silicones may be used in broad applications such as water treatment, food, medicine and healthcare, packaging, coatings, electronics, textiles, construction, and agriculture articles. Illustrative examples include antimicrobial wound care devices include medical devices, wound dressings, multi-layered contact lens materials, drug eluting or delivering medical devices, and wound care materials such as adhesives, transdermal patches, films, multi-layer dressings, and tissue scaffolds. The resulting silver-containing polymer composites comprising the silver-loaded silicone particles dispersed or loaded into the polymer matrices may also be used in moisture-curable construction sealants, agricultural applications such as water conservation for agrarian and civilian distribution systems, delivery and moisture management for personal care applications, cosmetics, silicone-hydrogel hybrid wound care materials, water-swellable materials for water sealing solutions, and reservoir systems.

### EXAMPLES

These examples are intended to illustrate the invention to one of ordinary skill in the art and should not be interpreted as limiting the scope of the invention set forth in the claims. All measurements and experiments were conducted at about 25° C., unless indicated otherwise.

As used herein,

“DOW CORNING® Trefil E-521” was obtained from Dow Corning Corporation (Midland, Mich.). DOW CORNING® Trefil E-521 is a biocompatible cured silicone powder.

An “E-48” silicone particle sample was prepared. The E-48 sample was prepared by phase inverse emulsion polymerization as follows. 50.0 g MD₁₆₉D′₂₃M and 4.61 g of tetra(dimethylvinylsiloxy)silane (Si[OSi(CH₃)₂CH═CH₂]₄) were weighed into a polypropylene cup and then ˜0.05 g of Kasterdt's catalyst with 0.51 wt. % Pt added. The mixture was spun for 10 sec. in a rotary mixer (SpeedMixer DAC 150 FVZ, Hauschild, Germany). 1.06 g ARLASOLVE® 200 (70 wt. % dispersion into water) in water was added followed by 2 g of deionized water. The cup was spun at a spinning speed of ca. 3540 rpm for 20 sec. The mixture was observed to have inverted into an oil/water (o/w) emulsion. The cup was spun for an additional 20 sec. at maximum speed, after which 2.5 g of additional water was added. The cup was spun for 15 sec. at a speed of ca. 2000 rpm. This was followed by adding an additional 6.5 g of dilution water and 15 sec. spinning at ca. 2000 rpm. A final addition of water was made such that the total amount of dilution water that had been added was 12 g. The cup was placed at room temperature for 60 hrs. The particles were harvested by filtration, and the resulting filter cake was washed with of water and then allowed to air dry overnight at ambient followed by an additional 2 hrs in a 50° C. oven for 2 hrs.

“MD₁₆₉D′₂₃M” was obtained from Dow Corning Corporation (Midland, Mich.) and has the chemical formula:

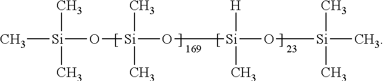

“MD₃D′₆M” was obtained from Dow Corning Corporation (Midland, Mich.) and has the chemical formula:

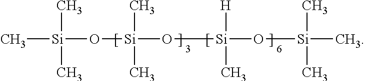

“SYLGARD® 184” is a two-component silicone elastomer from curing of the liquid mixture of Part A and Part B available as SYLGARD® 184 silicone elastomer kit and was obtained from Dow Corning Corporation (Midland, Mich.).

“DOW CORNING® MG-7-9900 SOFT SKIN ADHESIVE Part A” is an organopolysiloxane obtained from Dow Corning in Midland, Mich.

### Example 1

### Silver and Silver Compounds Loaded on DOW CORNING® Trefil E-521 by Dry Solid Blending

3.33 g of the silver and silver compounds listed below in Table A was mixed with 10.0 g of DOW CORNING® Trefil E-521 in a polypropylene cup by a rotary mixer (SpeedMixer DAC 150 FVZ) for 1 min. at a spinning speed of ca. 3540 rpm to load the silver/silver compounds onto the DOW CORNING® Trefil E-521. The particles obtained were characterized by SEM (scanning electron micrographs). The silver particles were observed on the surface of the DOW CORNING® Trefil E-521 particles or between the DOW CORNING® Trefil E-521 particles as noted below.

TABLE A

| | | Silver | |
|---|---|---|---|
| | | Compound | |
| Ex. 1, | | into Mixture | |
| Sample | Silver/Silver Compound | (vol. %) | Result* |
| 1 | Silver sulfate powder (4.82 μm | 5.65 | Silver dispersed on surface of |
| | in mean size) | | and among the DOW |
| | | | CORNING ® Trefil E-521 particles |
| | | | (referred to herein as 521Ag#1) |
| 2 | Silver powder (2-3.5 μm) | 3.02 | Silver dispersed on surface of |
| | (Aldrich, #327085, St. | | and among the DOW |
| | Louis, MO) | | CORNING ® Trefil E-521 particles |
| 3 | Silver citrate hydrate | 7.00 | Silver dispersed on surface of |
| | (Aldrich, #361259, pink | | and among the DOW |
| | powder) | | CORNING ® Trefil E-521 particles |
| 4 | Silver nanopowder (<100 nm, | 3.02 | Silver dispersed on surface of the |
| | Aldrich, black powder) | | DOW CORNING ® Trefil E-521 |
| | | | particles |
| 5 | Silver-copper nanopowder | 5.65 | Silver dispersed on surface of the |
| | (97.5/2.5 alloy, 70 nm in | | DOW CORNING ® Trefil E-521 |
| | size) (Aldrich, #576824, | | particles |
| | black powder) | | |
| 6 | Silver sulfadiazine (Aldrich, | 33.3** | Silver dispersed among the DOW |
| | #481181, white powder) | | CORNING ® Trefil E-521 particles |
| 7 | Silver carbonate (Aldrich, | 5.10 | Silver dispersed on surface of |
| | #179647, grey powder) | | and among the DOW |
| | | | CORNING ® Trefil E-521 particles |
| 8 | Silver benzoate (Aldrich, | 33.3** | Silver dispersed on surface of |
| | #227277, white powder) | | and among the DOW |
| | | | CORNING ® Trefil E-521 particles |
| 9 | Silver nitrate 10 wt. % on | 6.99*** | Silver dispersed on surface of |
| | silica gel (Aldrich, | | and among the DOW |
| | #248762, white beads, 230 mesh | | CORNING ® Trefil E-521 particles |
| | in size) | | |

*Observation by SEM (scanning electron microscopy)
**Weight percent (wt. %).
***10 wt. % silver nitrate on silica gel into the DOW CORNING ® Trefil E-521 mixture

### Example 2

### Silver Sulfide Loaded on E-48 by Dry Solid Blending

3.33 g of silver sulfide (Ag₂SO₄) was mixed with 10.0 g of E-48 in a polypropylene cup by a rotary mixer (SpeedMixer DAC 150 FVZ) for 1 min. at a spinning speed of ca. 3540 rpm to load the silver/silver compounds onto the E-48. The particles obtained were characterized by SEM, and the presence of silver particles was confirmed. The silver particles were observed as being uniformly dispersed on the surface of the E-48 particles.

### Example 3

### Silver Loaded on E-48 by Wet Blending

A silver colloidal dispersion (8.0 g of silver dispersion of 30-35 wt. % nanoparticles in triethylene glycol monomethyl ether, Aldrich, #736465) was mixed with 5.2 g of E-48 in a polypropylene cup by a rotary mixer (SpeedMixer DAC 150 FVZ) for 1 min. at a spinning speed of ca. 3540 rpm. The resulting wet mixture was maintained overnight at room temperature. The obtained mixture was then dried at 140° C. under reduced pressure followed by spinning with the rotary mixer for 1 min. at a spinning speed of ca. 3540 rpm. The obtained silver loaded E-48 dispersion (referred to herein as E-48Ag#2) contained 20 wt. % silver.

### Example 4

### Silver Nitrate Loaded on DOW CORNING® Trefil E-521 by Wet Blending

A silver nitrate (AgNO₃) aqueous solution (10.15 g into 12.7 g water) was mixed with 30.0 g of DOW CORNING® Trefil E-521 in a polypropylene cup by a dental mixer (SpeedMixer DAC 150 FVZ) for 1 min. at a spinning speed of ca. 3540 rpm. The resulting wet mixture was then dried at 140° C. under reduced pressure. The resulting grey powder was then mixed into a dental mixer for 1 min. at a spinning speed of ca. 3540 rpm. The particles obtained were characterized by SEM, and the presence of silver particles was confirmed.

### Example 5

### Silver Loaded on Polystyrene Microspheres by Wet Blending

A silver colloidal dispersion (8.0 g, silver dispersion of polystyrene particles from Aldrich, #479322, poly(styrene-co-divinylbenzene) with 1% crosslinking level, 200-400 mesh in size, 5.2 g) was mixed with the polystyrene microspheres in a polypropylene cup by a rotary mixer (SpeedMixer DAC 150 FVZ) for 1 min. at a spinning speed of ca. 3540 rpm. The resulting wet mixture was maintained overnight at room temperature. The obtained mixture was then dried at 140° C. under reduced pressure (boiling point 198° C., 122° C./10 mmHg for methyltriglycol) followed by spinning with the rotary mixer for 1 min. at a spinning speed of ca. 3540 rpm. The particles obtained were characterized by SEM, and the presence of silver particles was confirmed. The obtained silver loaded polystyrene microspheres (referred to herein as PS300Ag#2) contained 20 wt. % silver.

### Example 6

### Silver Loaded on DOW CORNING® Trefil E-521 by Electroless Deposition

### Step 1: Chemical Pretreatment of DOW CORNING® Trefil E-521 Particles

50.0 g of DOW CORNING® Trefil E-521 was surface-modified by mixing with 25.0 g sulfuric acid (98% conc.) in 200 ml of isopropanol in a polypropylene cup by a rotary mixer (SpeedMixer DAC 150 FVZ) for 1 min. at a spinning speed of ca. 2000 rpm. The resulting wet mixture with was maintained overnight at room temperature. The mixture was then dispersed into 800 mL of deionized water by ultrasonic mixing and then filtered. This dispersion and filtration process was repeated three times.

### Step 2: Silver Deposition

The modified DOW CORNING® Trefil E-521 sample was then surface-metallized using wet electroless plating technology. 10.0 g of the resulting particles were sensitized using 20 mL of an aqueous solution of SnCl₂ (0.1 M, Aldrich) for 30 min. in isopropanol (60 mL), which resulted in the adsorption of Sn²⁺ ions on the modified DOW CORNING® Trefil E-521 particle surface. After filtration, the obtained Sn²⁺ ion-sensitized DOW CORNING® Trefil E-521 particles were dipped into an aqueous solution of palladium chloride (PdCl₂, 5-10 wt. %. Aldrich) with hydrochloric acid (30 mmol) for 10 min. at 60° C. These Pd-modified particles were rinsed repeatedly with deionized water and acetone, and filtered and then immersed in a silver electroless solution (electroless silver, Transene Company, Danvers, Mass.) overnight. After filtration and washing with deionized water (200 mL) three times, the resulting powder was dried at 80° C. followed by spinning with the rotary mixer for 1 min. at a spinning speed of ca. 3540 rpm. The presence of Ag was confirmed by SEM.

### Example 7

### Silver Loading on Silicone Particles by Chemical Reduction

### Step 1: Preparation of the Silicone Particles

250 g of a methylhydrogen/dimethyl polysiloxane fluid (MD₁₆₉D′₂₃M) and 3.0 g (MD₃D′₆M) were weighed into a polypropylene cup. This was followed by 9.36 g of 1,5-hexadiene and 0.5 g of Kasterdt's catalyst with 0.51 wt. % Pt added. The mixture was spun for 10 sec. in a rotary mixer (SpeedMixer DAC 150 FVZ) at a spinning speed of ca. 3540 rpm. 3.15 g ARLASOLVE® 200 (70 wt. % dispersion into water, Croda USA, Edison, N.J.) in water was added followed by 6.0 g of deionized water (initial water). The cup was spun for 20 sec. at a spinning speed of ca. 3540 rpm. The mixture was observed to have inverted into an oil/water (o/w) emulsion. The cup was spun for an additional 20 sec. at maximum speed, after which 10.0 g of dilution water was added. The cup was spun for 15 sec. at a spinning speed of ca. 2000 rpm. This was followed by adding an additional 15.0 g of dilution water and 15 sec. spinning at ca. 2000 rpm. A final addition of water was made such that the total amount of dilution water that had been added was 35 g. The cup was placed at 50° C. for 2 hrs. The particles were harvested by filtration, and the resulting filter cake was washed with deionized water and then allowed to air dry overnight at ambient conditions followed by an additional 2 hrs in a 50° C. oven for 2 hrs.

### Step 2: Silver Deposition

10 g of a 3 wt. % aqueous solution of AgNO₃ was added to the emulsion and allowed to remain undisturbed for approximately 24 hrs at room temperature. The color of the emulsion changed from milky white to a very dark black-brown. The treated silicone elastomer particles were harvested by filtration and then washed with deionized water. The particles were dried at ambient temperature overnight followed by an additional 2 hrs in a 50° C. oven. The color of the particles was light brown. The presence of Ag was confirmed by X-ray fluorescence and found to be 0.3 wt. %. This product is referred to herein as E#1.

### Example 8

### Silver Loading on E-48 by Physical Deposition

Silver loading on solid microparticles of E-48 was realized by physical vapor deposition (PVD) using diode sputtering on a Cressington 208HR High Resolution Sputter Coater. The deposition was performed at room temperature at deposition times ranging from 0 to 130 sec., a total argon pressure of about 4 Pa, an electrode distance of 50 mm, and a current of 40 mA. The silver-target used for metal coating on the E-48 and other types of particles were purchased from Ted Pella, Inc. (Redding, Calif.). The E-48 sample was put in a Petri dish with a thickness smaller than 1 mm. The dish was then put inside the chamber, and kept moving during metal coating. The coating process was repeated 7 times, 10 nm/each (the thickness of the metal layer was calculated once the weight of metal deposited and the deposition area was known), and mixed the sample each time using a specula. The presence of Ag was confirmed by SEM.

### Example 9

### Storage Stability Into Silicone Liquid

Samples 1-8 in Table B are referenced to those in Table A in Ex. 1. Sample 9 in Table B is referenced to Ex. 4 above. Samples 10 and 11 in Table B were prepared from 4.0 g of the silver compounds mixed with 12.0 g of DOW CORNING® Trefil E-521 in a polypropylene cup by a rotary mixer (SpeedMixer DAC 150 FVZ) for 1 min. at a spinning speed of ca. 3450 rpm to load the silver/silver compounds onto the DOW CORNING® Trefil E-521. The silver and silver compounds loaded onto the DOW CORNING® Trefil E-521 (0.300 g of each) were added to DOW CORNING® MG-7-9900 SOFT SKIN ADHESIVE Part A silicone liquid (5.70 g) in a polypropylene cup by a rotary mixer (SpeedMixer DAC 150 FVZ) for 20 sec. at a spinning speed of ca. 3540 rpm. The uniform mixture was instantly poured into a transparent glass vial (1.5 cm in diameter, 5.0 cm in height) to a height of 3.2 cm. The storage stability of the cloudy mixture of silver particles into the silicone liquid was evaluated in the vial at room temperature under quiescent state. During storage, a clear silicone liquid layer was found on the top of the vial containing this mixture in the case of silver-loaded particles with a higher density than silicone liquid, or at the bottom of the vial in the case of silver-loaded particles with a lower density. A higher height value of the clear silicone liquid layer at a certain storage time indicated poorer storage stability for the silver-loading particles into silicone.

The results of the storage life for silver loading particles are summarized in Table B where the height (cm) of a clear liquid corresponds to the observation time (3 hr & 24 hr).

TABLE B

| | | Height | Height |
|---|---|---|---|
| Ex. 9, | | @ 3 hrs | @ 24 hrs |
| Sample | Silver/Silver Compound + DOW CORNING ® Trefil E-521 | (cm) | (cm) |
| 1 | Silver sulfate on DOW CORNING ® Trefil E-521 (Ex. 1, | 0.1 | 0.2 |
| | Sample 1) | | |
| 2 | Silver on DOW CORNING ® Trefil E-521 (Ex. 1, Sample 2) | 0.15 | 0.4 |
| 3 | Silver citrate on DOW CORNING ® Trefil E-521 (Ex. 1, | 0.1 | 0.1 |
| | Sample 3) | | |
| 4 | Silver nanopowder on DOW CORNING ® Trefil E-521 (Ex. 1, | 0 | 0 |
| | Sample 4) | | |
| 5 | Silver-copper nanopowder on DOW CORNING ® Trefil E-521 | 0 | 0 |
| | (Ex. 1, Sample 5) | | |
| 6 | Silver sulfadiazine on DOW CORNING ® Trefil E-521 (Ex. 1, | 0.05 | 0.2 |
| | Sample 6) | | |
| 7 | Silver carbonate on DOW CORNING ® Trefil E-521 (Ex. 1, | 0.1 | 0.2 |
| | Sample 7) | | |
| 8 | Silver benzoate on DOW CORNING ® Trefil E-521 (Ex. 1, | 0.15 | 0.15 |
| | Sample 8) | | |
| 9 | Silver nitrate on DOW CORNING ® Trefil E-521 (Ex. 4) | 0.1 | 0.5 |
| 10 | Silver carbonate, 50 wt. % on Celite (Aldrich, #363685, | 0.2 | 0.25 |
| | greenish powder) on DOW CORNING ® Trefil E-521 | | |
| 11 | Silver lactate (Aldrich, #359750, dark grey powder) on DOW | 0.05 | 0.15 |
| | CORNING ® Trefil E-521 | | |

### Example 10

### Storage Stability Into Silicone Liquid

Sample 1 was a control of silver sulfate powder.

For Sample 2, 0.30 g of silver sulfite with liquid was mixed with 3.00 g of DOW CORNING® Trefil E-521 in a polypropylene cup by a rotary mixer (Speed Mixer DAC 150 FVZ) for 20 sec. at a spinning speed of ca. 3540 rpm.

For Sample 3, 1.00 g of silver sulfate was mixed with 3.3 g wet DOW CORNING® Trefil E-521 particles, where the wet DOW CORNING® Trefil E-521 particles were prepared by 0.3 g liquid mixed with 3.0 g DOW CORNING® Trefil E-521 in a polypropylene cup with a rotary mixer for 20 sec. at a spinning speed of ca. 3540 rpm, in a polypropylene cup by the rotary mixer for 20 sec. at a spinning speed of ca. 3540 rpm. For Samples 3-6, the following liquids were also added (1) a-tocopherol (Aldrich, yellow viscous liquid), (2) linalool (colorless, low viscous liquid, Alfa Aesar, Ward Hill, Mass.), (3) 4-allyanisole (colorless liquid, Alfa Aesar), and (4) L-Ascorbic acid (slightly yellow liquid, Aldrich) prior to mixing.

The silver and silver compounds of Samples 2-6 loaded onto the DOW CORNING® Trefil E-521 (0.300 g of each) were added to DOW CORNING® MG-7-9900 SOFT SKIN ADHESIVE Part A silicone liquid (5.70 g) in a polypropylene cup by a rotary mixer (SpeedMixer DAC 150 FVZ) for 20 sec. at a spinning speed of ca. 3540 rpm. The uniform mixture was instantly poured into a transparent glass vial (1.5 cm in diameter, 5.0 cm in height) to a height of 3.2 cm. The storage stability of the cloudy mixture of silver particles into the silicone liquid was evaluated in the vial at room temperature under quiescent state. During storage, a clear silicone liquid layer was found on the top of the vial containing this mixture in the case of silver-loaded particles with a higher density than silicone liquid, or at the bottom of the vial in the case of silver-loaded particles with a lower density. A higher height value at a certain storage time indicated poorer storage stability for the silver-loading particles into silicone.

The results of the storage life for silver loading particles are summarized in Table C where the height (cm) of a clear liquid corresponds to the observation time (hr).

TABLE C

| | | | Height |
|---|---|---|---|
| Ex. 10, | | Height @ | @ 24 hr |
| Sample | Silver/Silver Compound | 3 hr (cm) | (cm) |
| 1 | Silver sulfate powder | 0.1 | 2.3 |
| | (4.82 μm in mean size) (Control) | | |
| 2 | Silver sulfate on DOW CORNING ® | 0.1 | 0.2 |
| | Trefil E-521 (Ex. 1, Sample 1) | | |
| 3 | Silver sulfate on wet DOW CORNING ® | 0.1 | 0.3 |
| | Trefil E-521 with a-tocopherol | | |
| 4 | Silver sulfate on wet DOW CORNING ® | 0.1 | 0.3 |
| | Trefil E-521 with linalool | | |
| 5 | Silver sulfate on wet DOW CORNING ® | 0.15 | 0.3 |
| | Trefil E-521 with 4-allylanisole | | |
| 6 | Silver sulfate on wet DOW CORNING ® | 0.1 | 0.9 |
| | Trefil E-521 with L-ascorbic acid | | |

### Example 11

### Storage Stability into Silicone Liquid

The silver and silver compounds listed in Table D below (0.30 g of each) were added to DOW CORNING® MG-7-9900 SOFT SKIN ADHESIVE Part A silicone liquid (5.70 g) in a polypropylene cup by a rotary mixer (SpeedMixer DAC 150 FVZ) for 20 sec. at a spinning speed of ca. 3540 rpm. The uniform mixture was instantly poured into a transparent glass vial (1.5 cm in diameter, 5.0 cm in height) to a height of 3.2 cm. The storage stability of the cloudy mixture of silver particles into the silicone liquid was evaluated in the vial at room temperature under quiescent state. During storage, a clear silicone liquid layer was found on the top of the vial containing this mixture in the case of silver-loaded particles with a higher density than silicone liquid, or at the bottom of the vial in the case of silver-loaded particles with a lower density. A higher height value at a certain storage time indicated a poorer storage stability for the silver-loading particles into silicone.

The results of the storage life for silver loading particles are summarized in Table D where the height (cm) of a clear liquid corresponds to the observation time (hr).

TABLE D

| Ex. 11, | | Height @ | Height @ |
|---|---|---|---|
| Sample | Silver/Silver Compound | 3 hr (cm) | 24 hr (cm) |
| 1 | Silver sulfate powder (4.82 μm in mean size) | 0.1 | 2.3 |
| 2 | Silver sulfate on DOW CORNING ® Trefil E-521 (Ex. 1, | 0.1 | 0.2 |
| | Sample 1) | | |
| 3 | Silver nitrate (Aldrich, crystal) | 3.0 | 3.1 |
| 4 | Silver nitrate on DOW CORNING ® Trefil E-521 by wet | 0.1 | 0.5 |
| | loading (Ex. 4) | | |
| 5 | 10 wt. % silver nitrate on silica gel (Aldrich, #248762, | 0.4 | 2.5 |
| | white beads) | | |
| 6 | CONDUCT-O-FIL ® S5000-S3, Ag @ glass (gray | 0.2 | 0.2 |
| | powder, Potters Industries, Inc., Carlstadt, NJ) | | |
| 7 | CONDUCT-O-FIL ® SH230-S33, Ag @ hollow glass | 0 | 1.2* |
| | (gray powder, Potters Industries, Inc.) | | |
| 8 | Silver on E-48 (Ex. 2) | 0 | 0.2 |
| 9 | Silver on polystyrene (Ex. 5) | 0.2 | 0.2 |
| 10 | Milliken silver ceramic powder (Milliken & Company, | 0.1 | 0.15 |
| | Spartanburg, SC) | | |

*The silver-loaded hollow glass particles had a lower density than the silicone liquid, and the height corresponded to the height of the clear silicone layer at the bottom of vial.

### Example 12

### Antimicrobial Testing of Silver-Containing Silicone Dispersions

SYLGARD® 184 (20 g) was mixed with the listed amounts of silver, silver compounds, sliver-loaded DOW CORNING® Trefil E-521, or silver-loaded carrier (for example, glass, polystyrene) into a polypropylene cup on a rotary mixer (SpeedMixer DAC 150 FVZ) for 30 sec. at a speed of ca. 3540 rpm and then de-aired. The resulting silicone liquid mixtures (9.50 g) were poured into a polystyrene dish (Sterile Fisherband dish with 100×15 mm) and then instantly put into an oven at 120° C. for 5-10 min. to be cured into a silicone elastomeric film with a thickness of ca. 1.2 mm for antimicrobial test.

The antimicrobial testing was in accordance with ASTM E2149-10, entitled “Standard Test Method for Determining the Antimicrobial Activity of Immobilized Antimicrobial Agents Under Dynamic Contact Conditions.” The Zone of Inhibition (ZOI) analysis followed the normal method of the ZOI Test, Kirby-Bauer Test: a microbial suspension was spread evenly by a sterile swab over the face of a sterile agar plate. The antimicrobial agent was applied to the center of the agar plate in a fashion such that the antimicrobial did not spread out from the center and incubated. Substantial antimicrobial activity was present as a zone of inhibition appearing around the test product. A larger zone of inhibition usually means that the antimicrobial is more potent. The antimicrobial test results are summarized in Table E below.

TABLE E

| | | | Silver | ASTM | |
|---|---|---|---|---|---|
| Ex. 12, | | | content | 2149 | |
| Sample | Formulation | Silver resource | (wt %) | log red'n | ZOI |
| 1 | SYLGARD ® 184 100 | None (Control) | 0 | 0.1 | None |
| 2 | SYLGARD ® 184 100 | None (Control) | 0 | 0 | None |
| | DOW CORNING ® Trefil E-521 | | | | |
| | 7.5 | | | | |
| 3 | SYLGARD ® 184 100 | Silver sulfate | 0.342 | 4.9 | None |
| | Silver sulfate powder 1.0 | powder used in | | | |
| | | Ex. 1, Sample 1 | | | |
| 4 | SYLGARD ® 184 100 | Ex. 1, Sample 1 | 0.333 | 4.9 | None |
| | Ex. 1, Sample 1 4.0 | | | | |
| 5 | SYLGARD ® 184 100 | Silver powder | 0.990 | 0.3 | None |
| | Silver microparticles 1.0 | used in Ex. 1, | | | |
| | | Sample 2 | | | |
| 6 | SYLGARD ® 184 100 | Silver powder | 1.960 | 0.3 | None |
| | Silver microparticles 2.0 | used in Ex. 1, | | | |
| | | Sample 2 | | | |
| 7 | SYLGARD ® 184 100 | Ex. 1, Sample 2 | 0.962 | 0.2 | None |
| | Ex. 1, Sample 2 4.0 | | | | |
| 8 | SYLGARD ® 184 100 | Silver citrate | 0.201 | 4.8 | Zone |
| | Silver citrate hydrate 1.0 | hydrate used in | | | |
| | | Ex. 1, Sample 3 | | | |
| 9 | SYLGARD ® 184 100 | Ex. 1, Sample 3 | 0.195 | 4.8 | Zone |
| | Ex. 1, Sample 3 4.0 | | | | |
| 10 | SYLGARD ® 184 100 | Silver | 0.990 | 2.9 | None |
| | Silver nanoparticles 1.0 | nanoparticles | | | |
| | | used in Ex. 1, | | | |
| | | Sample 4 | | | |
| 11 | SYLGARD ® 184 100 | Ex. 1, Sample 4 | 0.962 | 0.84 | None |
| | Ex. 1, Sample 4 4.0 | | | | |
| 12 | SYLGARD ® 184 100 | Silver-copper | 0.960 | 0 | None |
| | Silver-copper nanoparticles 1.0 | nanoparticles | | | |
| | | used in Ex. 1, | | | |
| | | Sample 5 | | | |
| 13 | SYLGARD ® 184 100 | Ex. 1, Sample 5 | 0.933 | 0.3 | None |
| | Ex. 1, Sample 5 4.0 | | | | |
| 14 | SYLGARD ® 184 100 | Silver sulfadiazine | 0.299 | 0.2 | None |
| | Silver sulfadiazine 1.0 | used in Ex. 1, | | | |
| | | Sample 6 | | | |
| 15 | SYLGARD ® 184 100 | Ex. 1, Sample 6 | 0.290 | 0.1 | None |
| | Ex. 1, Sample 6 4.0 | | | | |
| 16 | SYLGARD ® 184 100 | Silver carbonate | 0.387 | 4.8 | Zone |
| | Silver carbonate 1.0 | used in Ex. 1, | | | |
| | | Sample 7 | | | |
| 17 | SYLGARD ® 184 100 | Ex. 1, Sample 7 | 0.376 | 4.8 | Zone |
| | Ex. 1, Sample 7 4.0 | | | | |
| 18 | SYLGARD ® 184 100 | Silver benzoate | 0.466 | 4.8 | Zone |
| | Silver benzoate 1.0 | used in Ex. 1, | | | |
| | | Sample 8 | | | |
| 19 | SYLGARD ® 184 100 | Ex. 1, Sample 8 | 0.453 | 4.8 | None |
| | Ex. 1, Sample 8 4.0 | | | | |
| 20 | SYLGARD ® 184 100 | Silver nitrate | 0.629 | 4.3 | Zone |
| | Silver nitrate 1.0 | (Aldrich, #S6506, | | | |
| | | colorless crystals) | | | |
| 21 | SYLGARD ® 184 100 | Ex. 4 | 0.611 | 4.3 | Zone |
| | Silver nitrate on DOW | | | | |
| | CORNING ® Trefil E-521 | | | | |
| | 4.0 | | | | |
| 22 | SYLGARD ® 184 100 | Silver nitrate 10 wt. % | 0.302 | 4.3 | Zone |
| | Silver nitrate on silica gel 5.0 | on silica gel | | | |
| | | (Aldrich, | | | |
| | | #248762, white | | | |
| | | beads, 230 mesh | | | |
| | | in size) (Silver | | | |
| | | used in Ex. 1, | | | |
| | | Sample 9) | | | |
| 23 | SYLGARD ® 184 100 | Ex. 1, Sample 10 | 0.144 | 4.3 | Zone |
| | Ex. 1, Sample 10 10.0 | | | | |
| 24 | SYLGARD ® 184 100 | Ex. 3 (E-48Ag#2) | 0.952 | 0 | None |
| | Ex. 3 (E-48Ag#2) 5.0 | | | | |
| 25 | SYLGARD ® 184 100 | Ex. 7 (E#1) | 0.003 | 0 | None |
| | Ex. 7 (E#1) 1.0 | | | | |
| 26 | SYLGARD ® 184 100 | Ex. 5 | 0.952 | 0.4 | None |
| | Ex. 5 (PS300Ag#2) 5.0 | (PS300Ag#2) | | | |
| 27 | SYLGARD ® 184 100 | Silver sulfadiazine | 0.387 | 4.8 | Zone |
| | Silver sulfadiazine 1.0 | used in Ex. 1, | | | |
| | | Sample 8 | | | |
| 28 | SYLGARD ® 184 100 | Ex. 1, Sample 8 | 0.376 | 4.8 | Zone |
| | Ex. 1, Sample 8 4.0 | | | | |
| 29 | SYLGARD ® 184 100 | Ex. 1, Sample 8 | 0.192 | 4.3 | None |
| | Ex. 1, Sample 8 2.0 | | | | |
| 30 | SYLGARD ® 184 100 | Ex. 1, Sample 8 | 0.097 | 4.3 | None |
| | Ex. 1, Sample 8 1.0 | | | | |
| 31 | SYLGARD ® 184 100 | CONDUCT-O- | 0.923 | 0 | None |
| | CONDUCT-O- | FIL ® S5000-S3 | | | |
| | FIL ® S5000-S3 8.3 | (Potters | | | |
| | | Industries, Inc.) | | | |
| 32 | SYLGARD ® 184 100 | SELECTSILVER ® | 0.108 | 4.3 | None |
| | SELECTSILVER ® SR12 | SR12 (Milliken | | | |
| | 6.4 | & Company) | | | |
| 33 | SYLGARD ® 184 100 | ALPHASAN ® | 0.229 | 0 | None |
| | ALPHASAN ® RC-2000 | RC-2000 (Milliken | | | |
| | 6.4 | & Company) | | | |

While the invention is susceptible to various modifications and alternative forms, specific embodiments have been shown by way of example in the drawings and described in detail herein. It should be understood, however, that the invention is not intended to be limited to the particular forms disclosed. Rather, the invention is to cover all modifications, equivalents, and alternatives falling within the spirit and scope of the invention as defined by the appended claims.

1. A method for forming a curable silver-containing silicone dispersion having stability against precipitation of silver solid comprising:
providing silicone particles, silver-containing particles and a silicone formulation;
mixing the silicone particles with the silver-containing particles to form silver-loaded silicone particles; and
loading the silver-loaded silicone particles into a silicone formulation by mixing to form a curable silver-containing silicone dispersion having stability against precipitation of the silver-containing particles.

2. The method of claim 1 wherein the mixing is by wet blending or dry blending.

3. The method according to claim 1, wherein the silver-containing particles are solid microparticles or nanoparticles of silver and silver compounds.

4. (canceled)

5. (canceled)

6. (canceled)

7. (canceled)

8. A method for forming a curable silver-containing silicone dispersion having stability against precipitation of silver solid comprising:
providing silicone particles containing an excessive number of —SiH groups, silver-containing particles and a silicone formulation;
mixing the silicone particles with a dispersion or an emulsion containing the silver-containing particles or a solution containing the silver-containing particles to form silver-loaded silicone particles;
isolating the silver-loaded elastomeric particles; and
loading the silver-loaded silicone particles into a silicone formulation by mixing to form a curable silver-containing silicone dispersion having stability against precipitation of the silver-containing particles.

9. The method according to claim 8, wherein the silver-containing particles are solid microparticles or nanoparticles of silver and silver compounds.

10. (canceled)

11. (canceled)

12. A curable silver-containing silicone dispersion having stability against precipitation of silver solid comprising:
silver-loaded silicone particles comprising siloxy units of (RR¹R²SiO_{1/2}), (R¹R²SiO_{2/2}), (RSiO_{3/2}), and/or (SiO_{4/2}) where R, R¹, R² is independently selected from hydrogen atom and a monovalent organic group having a loading content of silver in the range of from about 0.1 to about 70 wt. % of the total amount of the silver-loaded silicone particles, wherein the silver-loaded silicone particles are loaded in a liquid silicone formulation containing siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group in the range of from about 0.01 to about 50 wt. % of the silicone.

13. (canceled)

14. (canceled)

15. The method according to claim 1, wherein the silicone particles comprise siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group and the silicone formulation is a liquid silicone formulation containing siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group.

16. The method according to claim 8, wherein the silicone particles comprise siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group and the silicone formulation is a liquid silicone formulation containing siloxy units of (RR¹R²SiO_{1/2}), (R¹R²SiO_{2/2}), (RSiO_{3/2}), or (SiO_{4/2}) where R, R¹, R² is independently selected from a hydrogen atom and a monovalent organic group.

17. The method according to claim 1, wherein the silicone particles are silicone elastomeric particles.

18. The method according to claim 8, wherein the silicone particles are silicone elastomeric particles.

19. The curable silver-containing silicone dispersion according to claim 12, wherein the silicone particles are silicone elastomeric particles.

20. The method according to claim 15, wherein the silicone particles are silicone elastomeric particles.

21. The method according to claim 16, wherein the silicone particles are silicone elastomeric particles.

22. The curable silver-containing silicone dispersion according to claim 12, wherein the monovalent organic group is vinyl.

23. The method according to claim 15, wherein the monovalent organic group is vinyl.

24. The method according to claim 16, wherein the monovalent organic group is vinyl.

25. The method according to claim 1, wherein the particle size of the silicone particles ranges from 0.5 to 100 microns in average diameter.

26. The method according to claim 8, wherein the particle size of the silicone particles ranges from 0.5 to 100 microns in average diameter.

27. The curable silver-containing silicone dispersion according to claim 12, wherein the particle size of the silicone particles ranges from 0.5 to 100 microns in average diameter.

28. The method according to claim 15, wherein the particle size of the silicone particles ranges from 0.5 to 100 microns in average diameter.

29. The method according to claim 16, wherein the particle size of the silicone particles ranges from 0.5 to 10 microns in average diameter.
